(19) United States
(12) Patent Application Publication
(10) Pub. No.: US 2006/0125285 A1
(43) Pub. Date: Jun. 15, 2006

(54) Molding clip

(76) Inventors: Suguru Mizukoshi, Utsunomiya-shi (JP); Nobuyuki Inami, Utsunomiya-shi (JP)

Correspondence Address: MILES & STOCKBRIDGE PC, 1751 PINNACLE DRIVE, SUITE 500, MCLEAN, VA, 22102-3833, US

(21) Appl. No.: 11/240,489

(22) Filed: Oct. 3, 2005

(30) Foreign Application Priority Data
Oct. 6, 2004 (JP) JP2004-293670

(51) Int. Cl. B62D 29/04

(52) U.S. Cl. 296/181.2

(57) ABSTRACT

A molding clip comprises a molding holder including a base, and an attachment leg extending from the base for insertion into a mounting hole in a workpiece. The attachment leg has a first portion remote from the base for insertion in the mounting hole for temporary mounting of the clip and the molding on the workpiece, and a second portion adjacent to the base for insertion in the mounting hole to mount the clip and the molding on the workpiece permanently. The first portion has a pair of flexible plates that are inserted in the mounting hole and that have shoulders engaging an edge of the mounting hole. The second portion has a pair of flexible fingers that are inserted in the mounting hole and that have shoulders engaging an edge of the mounting hole.

### CROSS-REFERENCE TO RELATED APPLICATION

This application claims the benefit of Japanese patent application number 2004-293670 filed Oct. 6, 2004, incorporated herein by reference.

### BACKGROUND OF THE INVENTION

The present invention relates to a clip for mounting a molding on a workpiece, more particularly, a clip for mounting a drip molding for a portion of a side door on a car body frame.

A molding clip for mounting a door molding to a car body portion is disclosed in Japanese Unexamined Utility Model Application Publication 5-82695 (Patent Document 1: Corresponding to Utility Model Registration 2607173). In this molding clip, a bolt is inserted into the axial center of an attachment leg that is inserted and fixed inside a mounting hole in a workpiece, such as a portion of a car body. When the mounting bolt is screwed into the attachment leg, a portion of the attachment leg extends laterally, and the car body portion is held securely between the extended portion and the molding clip. Before the bolt is placed into the attachment leg and screwed in, the molding clip holding the molding is temporarily mounted in the mounting hole of the car body.

With the clip disclosed in Japanese Unexamined Utility Model Application Publication 3-107 (Patent Document 2), a plurality of components are connected together and an open mounting hole is closed. This clip comprises a flange, an attachment leg depending from the flange, and a temporary attachment portion attached to an end of the attachment leg. The temporary attachment portion has a unique shape in which a plurality of thin, flexible, round plates are formed at set intervals on a tubular shank extending from an end of the attachment leg. The temporary attachment portion is temporarily mounted in the mounting hole of a workpiece, and the flange is set at a particular interval from the surface of the workpiece during temporary mounting. If the workpiece, such as the surface of a car body, uses a clip with a flange that is to be painted, the clip can be attached temporarily so that the surface of the car body and surfaces of the flange can be painted the same color.

The clip described in Japanese Unexamined Patent Application Publication 61-096210 (Patent Document 3) consists of a flange, an attachment leg depending from the flange, and a flexible, slender rod-shaped drop-prevention finger extending from an end of the attachment leg in a direction perpendicular to the axis of the leg. When the drop-prevention finger is inserted into a mounting hole in a workpiece, the clip is kept from dropping out of the workpiece while the attachment leg is not inserted into the mounting hole.

In Japanese Unexamined Patent Application Publication 2004-098733 (Patent Document 4), an attachment base for a metal clip used to mount inner trim to a car body is provided in the inner trim. To prevent damage to the car body when the metal clip is inserted into a mounting hole of the car body, a drop-prevention rib higher than the clip is attached to the inner trim near the attachment base. An embodiment in which an attachment groove for temporary attachment is formed in the drop-prevention rib is shown in FIG. 5 and FIG. 6 of Patent Document 4.

When a molding such as a drip molding is to be mounted on a workpiece such as a car body, for example, a molding clip can be attached beforehand to the molding, the molding with the molding clip attached can be transported to an automotive assembly line, the molding clip can then be positioned for insertion into a mounting hole in the car body, and pressure can then be applied to the molding on the car body side to attach the molding to the car body.

If the molding has to be attached from the bottom of the car body, it is desirable that the molding clip be attached temporarily before final mounting so that a worker can hold the molding clip beneath the mounting position on the car and push it into the car body above. A temporary attachment function is especially needed if the molding is long and heavy. Temporary attachment makes the operation more efficient, because it allows a single worker to make fine adjustments to the molding attachment position on the car body before mounting the molding properly on the car body.

The molding clip in Patent Document 1 has a temporary attachment function on its attachment leg, but a bolt has to be inserted into the center of an attachment leg. Also, the bolt inserted for temporary attachment has to be screwed in from an end of the attachment leg. Therefore, this molding attachment operation is inconvenient. Patent Document 2 does not mention temporary attachment of the molding to a workpiece such as a car body. As stated earlier, the clip in Patent Document 2 has a unique shape in which a plurality of thin, flexible, round plates are formed at set intervals on shank extending from an end of an attachment leg. This arrangement cannot be easily used to insert a molding into a mounting hole on a car body. The shape of the attachment leg is intricate and may damage the edge of the mounting hole when inserted into a mounting hole on a car body. Thus, the clip is ill-suited for attachment of a molding.

The clip in Patent Document 3 only has a function that keeps the clip from falling out of a mounting hole when attached temporarily. The drop-preventing finger is rod-shaped and extends perpendicularly at an end of an attachment leg. This makes insertion into a mounting hole difficult and may damage the edge of the mounting hole during insertion. Thus, the clip is ill-suited for attaching a molding. Because the metal clip in Patent Document 4 does not have an appropriate temporary attachment function, the clip cannot be used to attach a molding where a temporary attachment function is required. Patent Document 4 has a drop-preventing rib on the inner trim near the clip attachment base in the inner trim. However, the drop-preventing rib itself does not have a temporary attachment function, and so the clip is not suitable as a molding clip.

### BRIEF DESCRIPTION OF THE INVENTION

An object of the present invention is to provide a molding clip in which a molding is attached to a molding clip and the clip is then mounted on a workpiece by simply pressing the clip into the workpiece at a predetermined position on the workpiece, and in which the clip has a temporary attachment function to enable a single worker to mount the molding from the underside of the workpiece.

In a preferred (non-limiting) embodiment, the present invention comprises a molding clip for mounting a molding such as a drip molding to a workpiece such as a car frame, wherein the molding clip comprises a molding holder for holding a molding and an attachment leg that is inserted into a mounting hole in the workpiece to engage the hole. A temporary attachment portion is formed at an end of the attachment leg to temporarily engage the mounting hole. The temporary attachment portion comprises a pair of flexible plates extending from a tapered insertion end.

The temporary attachment portion can be easily inserted into a mounting hole on a workpiece such as a car body. The molding attachment operation is simple, and the temporary attachment portion does not damage the edge of the mounting hole. Because of the temporary attachment function, the clip does not fall out during molding attachment, and a single worker can attach the molding temporarily from below, reposition the molding on the workpiece, and properly mount the molding.

The attachment leg has an anchor shape and comprises a shank extending from the molding holder and a pair of attachment fingers extending from an end of the shank towards the molding holder and away from the axis of the shank. The attachment leg is inserted into the mounting hole in the workpiece for permanent mounting of the molding.

### BRIEF DESCRIPTION OF THE DRAWINGS

The invention will be further described in conjunction with the accompanying drawings, which illustrate a preferred (best mode) embodiment, and wherein:

FIG. 1 is a plan view of the molding clip in a first embodiment of the present invention;

FIG. 2 is a front view of the molding clip in FIG. 1;

FIG. 3 is a left side view of the molding clip in FIG. 2;

FIG. 4 is a side view of the molding clip from line IV-IV in FIG. 3;

FIG. 5 is a side view of the molding clip from line V-V in FIG. 3;

FIG. 6 is a cross-sectional view showing a molding clip with a molding temporarily attached to a workpiece; and

FIG. 7 is a cross-sectional view showing the molding clip in FIG. 6 permanently attached to the workpiece.

### DETAILED DESCRIPTION OF THE INVENTION

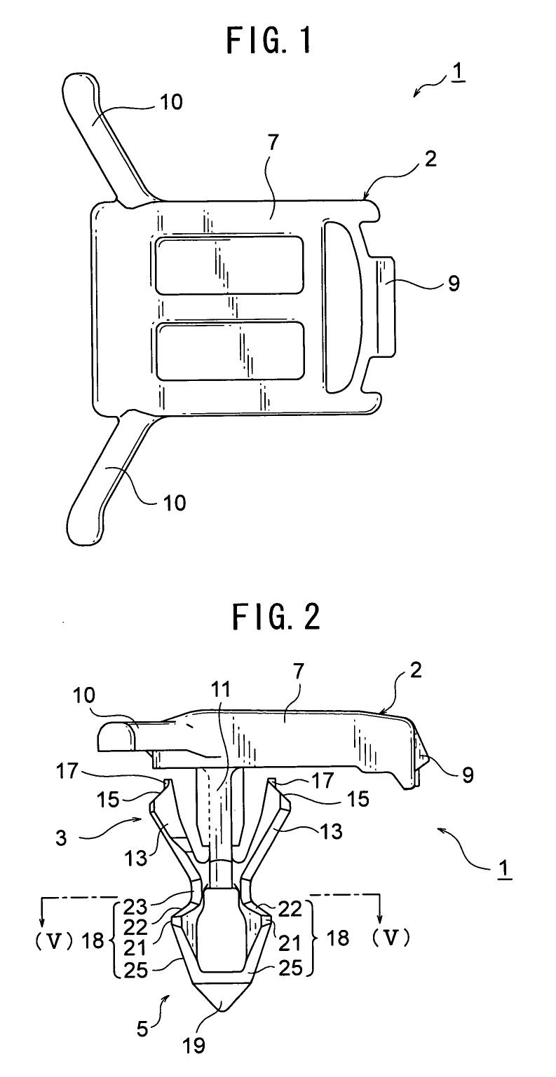

In one embodiment of the invention, a molding clip 1 is preferably a clip integrally made of hard plastic and used to mount a molding such as a drip panel, for example, to a workpiece such as a car body frame. As shown in FIG. 1 through FIG. 5, the molding clip, comprises a molding holder 2 for holding a molding, and an attachment leg 3 to be inserted into a mounting hole in a workpiece such as a car body. A temporary attachment portion 5 is formed on an end of the attachment leg 3 to temporarily engage the mounting hole.

The molding holder 2 is shaped so that it can be pushed entirely into a molding to engage edges at opposite ends of the molding and hold it in place. As shown in FIG. 1 and FIG. 2, the molding holder 2 comprises a rectangular plate-shaped base 7 to be inserted into a molding, a rigid shoulder 9 for engaging an edge at one end of the molding, and a pair of elastic wings 10 for engaging an edge at the other end of the molding. The clip 1 can be attached to the molding by inserting the elastic wings 10 into a portion of the molding at one of the molding edges, bending the wings 10 towards the edge, inserting the entire base 7 into the molding, and engaging the shoulder 9 with the other molding edge. The clip 1 is easily attached to the molding and can be mounted at various places on the molding.

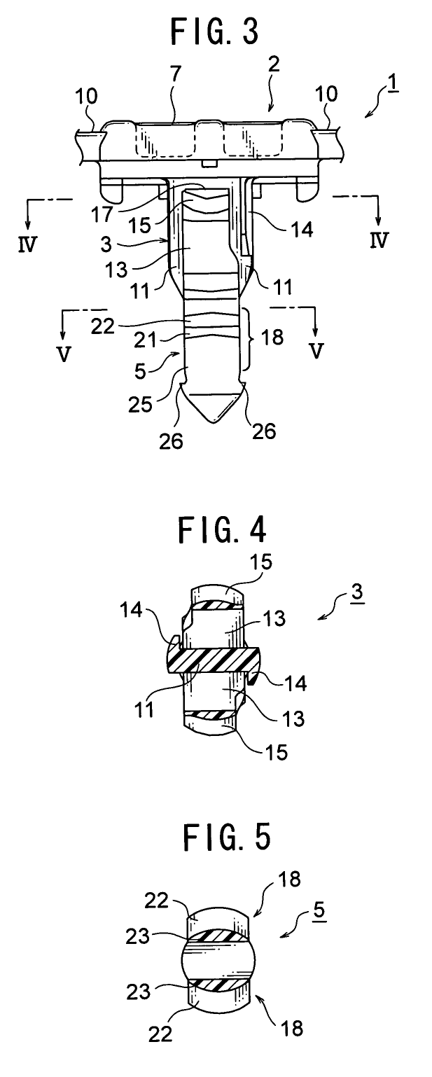

The attachment leg 3 is used to attach the molding held by the molding holder 2 to a workpiece such as a car body. In this embodiment, the attachment leg 3 is anchor-shaped and comprises a shank 11 extending from the molding holder 2 in the center of the base 7, and a pair of flexible fingers 13 extending from an end of the shank 11 towards the base 7 of the molding holder 2 and laterally away from the axis of the shank. The shank 11, as shown in FIG. 2 through FIG. 4, has a plate shape. It is made more rigid, as shown in FIG. 3 and FIG. 4, by ribs 14 extending lengthwise on the sides. The fingers 13 are able to bend towards and away from the shank 11. When no bending force is applied towards the shank, they return to the position shown in FIG. 2. Shoulders 15 on the end of the fingers 13 engage the edge of the mounting hole. A protrusion 17 is provided on each shoulder 15. The fingers 13 have a slender plate shape that is somewhat thicker in the center widthwise.

The temporary attachment portion 5 is formed so as to extend axially away from an end of the shank 11 on the attachment leg 3 (from which the attachment fingers 13 extend). More specifically, the temporary attachment portion 5 comprises a pair of flexible plates 18 connected to a tapered insertion end 19. As shown in FIG. 2, each of the plates 18 comprises a laterally projecting portion 21, a neck portion 23 closer to the axis of the attachment leg 3, a shoulder 22, and a tapered portion 25 extending from the projecting portion 21 towards the insertion end 19. Preferably, the insertion end 19 has a conical shape. As shown in FIG. 2, the temporary attachment portion 5 has a sort of canoe shape with a bored out center.

The temporary attachment portion 5 is easy to insert into a mounting hole in a workpiece and yet strongly engages the edge of the mounting hole during temporary attachment. Preferably, there are lateral protrusions 26 at a boundary region of the insertion end with the tapered portions 25 of the plates 18, as shown in FIG. 3. When the insertion end 19 is inserted into a mounting hole and the protrusions 26 reach the edge of the mounting hole, the protrusions 26 make a click. The operator senses the click, and recognizes that the insertion end 19 has been inserted into the mounting hole.

From the foregoing description, it is apparent that the temporary attachment portion 5, comprising the plates 18 and the insertion end 19, is remote from the base 7, while a permanent attachment portion, comprising the shank 11 and the fingers 13, is located between the temporary attachment portion and the base.

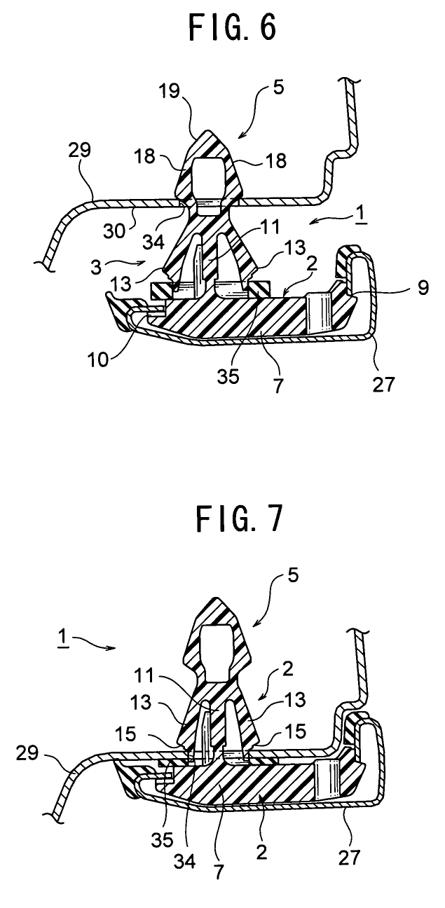

The following is an explanation of how a molding 27 such as a drip molding is mounted on a workpiece 29 such as a car body, with reference to FIG. 6 and FIG. 7. Here, the molding 1 is attached to the workpiece 29 from below and can be attached to the surface of the workpiece 29 by a single worker. The molding clip 1 can be attached to the molding 27 before the molding is mounted on the workpiece 29. The clip 1 is attached to the molding 27 by inserting the pair of elastic wings 10 on the molding holder 2 of the clip 1 into a region at one of the edges of the molding 27, the wings 10 are bend towards the edge, the entire base 7 is pushed into the molding 27, and the shoulder 9 is engaged with an opposite edge of the molding. In this way, the clip 1 can be easily attached to the molding. If the molding 27 is long, clips 1 can be attached at multiple locations on the molding 27 corresponding to multiple locations on the workpiece 29.

The molding 27 attached to the clip 1 can then be transported to an appropriate station on an automotive assembly line. Here, a worker takes the molding 27, positions the insertion end 19 of the temporary attachment portion 5 on the clip 1 under a mounting hole 34 in the workpiece 29, and gently pushes the clip 1 from the outside of the molding 27. See FIG. 6. Because the temporary attachment portion 5 extends to an end of the clip, it is easy to insert the clip into the mounting hole 34 in the workpiece 29, the molding mounting operation is easy, and the edge of the mounting hole 34 is not damaged by the temporary attachment portion 5. When the temporary attachment portion 5 is pushed through the mounting hole 34, the shoulders 22 on the plates 18 (FIG. 2) engage the edge of the mounting hole 34, and the molding 27 is temporarily attached to the workpiece 29.

Another clip 1 attached to the molding 27 can be temporarily attached at another position on the workpiece 29. Even when temporarily attached to the underside of a workpiece as shown in the drawings, the molding does not fall out. This allows a single worker to mount the molding from beneath the workpiece. While the molding is temporarily attached as shown in FIG. 6, the worker can reposition the molding on the workpiece and then permanently mount the molding on the workpiece by applying pressure to the clips 1 from the outside surface of the molding.

As shown in FIG. 7, the pair of elastic fingers 13 on the leg 3 pass through the mounting hole, and the shoulders 15 engage the edge of the mounting hole. This permanently mounts the clips 1 on the workpiece. When the clips 1 holding the molding 27 have been permanently mounted on the workpiece 29, the molding 27 is permanently attached to the workpiece. This makes the mounting operation easy.

As shown in FIG. 6 and FIG. 7, an elastic pad 35 is preferably positioned between the base 7 of the molding holder 2 and the fingers 13. During permanent mounting, pressure is applied to the elastic pad 35 by the base 7 on the molding holder 2. The rebounding force from the elastic pad 35 brings the shoulders 15 on the fingers 13 into strong contact with the edge of the mounting hole 34, and the mounting strength during the permanent mounting operation is improved.

While a preferred embodiment of the invention has been shown and described, changes can be made without departing from the principles and spirit of the invention, the scope of which is defined in the following claims.

The invention claimed is:

1. A molding clip for mounting a molding such as a drip molding to a workpiece such as a car frame, wherein the molding clip comprises a molding holder for holding a molding and an attachment leg for insertion into a mounting hole in the workpiece, wherein a temporary attachment portion is formed at an end of the attachment leg for insertion in the mounting hole, and wherein the temporary attachment portion comprises a pair of flexible plates extending to a tapered insertion end connected to the pair of plates.

2. The molding clip described in claim 1, wherein each of the plates comprises a laterally projecting portion near the end of the attachment leg, a neck portion closer to an axis of the attachment leg, a shoulder, and a tapered portion extending towards the insertion end, and wherein the shoulders engage an edge of the mounting hole when the temporary attachment portion is inserted in the hole.

3. The molding clip described in claim 2, wherein there are lateral protrusions at a boundary region of the insertion end with the tapered portions.

4. The molding clip described in claim 1, wherein the attachment leg has an anchor shape and comprises a shank extending from a base of the molding holder and a pair of fingers extending from an end of the shank towards the base and away from an axis of the attachment leg, and wherein the fingers have shoulders that engage the edge of the mounting hole in the workpiece when the attachment leg is permanently inserted in the hole.

5. A molding clip for mounting a molding on a workpiece, comprising a base constructed for insertion in the molding and an attachment leg extending from the base for insertion in a mounting hole in the workpiece, wherein the attachment leg comprises:
a temporary attachment portion remote from the base and constructed for insertion in the mounting hole for temporary mounting of the clip and the molding on the workpiece; and
a permanent attachment portion between the temporary attachment portion and the base for insertion in the mounting hole for permanent mounting of the clip and the molding on the workpiece, wherein
the temporary attachment portion tapers laterally outward from an insertion end and has shoulders disposed to engage an edge of the mounting hole when the temporary attachment portion is inserted in the mounting hole.

6. The molding clip described in claim 5, wherein the temporary attachment portion includes a pair of flexible plates diverging from one another from the insertion end toward the base.

7. The molding clip described in claim 5, wherein the permanent attachment portion comprises a pair of flexible fingers extending along the shank from the temporary attachment portion and diverging from one another, and wherein the fingers have shoulders disposed to engage an edge of the attachment hole when the permanent attachment portion is inserted into the attachment hole.

8. The molding clip described in claim 5, wherein the attachment leg has a neck between the temporary attachment portion and the permanent attachment portion.

9. The molding clip described in claim 5, wherein the entire clip is an integral plastic molding.
